(19) United States
(12) Patent Application Publication
(10) Pub. No.: US 2020/0227002 A1
(43) Pub. Date: Jul. 16, 2020

(54) PROFILE INFORMATION DISPLAY APPARATUS, PROFILE INFORMATION DISPLAY METHOD, AND NON-TRANSITORY COMPUTER-READABLE STORAGE MEDIUM STORING PROFILE INFORMATION DISPLAY PROGRAM

(71) Applicant: SEIKO EPSON CORPORATION, Tokyo (JP)

(72) Inventors: Yuko YAMAMOTO, Shiojiri (JP); Takahiro KAMADA, Matsumoto (JP); Takumi SHIMOMUKAI, Matsumoto (JP); Shotaro MATSUDA, Matsumoto (JP); Masayuki SEKO, Matsumoto (JP); Kenji MATSUZAKA, Shiojiri (JP)

(21) Appl. No.: 16/736,918

(22) Filed: Jan. 8, 2020

(30) Foreign Application Priority Data
Jan. 10, 2019 (JP) 2019-002441

(51) Int. Cl. G09G 5/02

(52) U.S. Cl. CPC G09G 5/02; G09G 2340/06

(57) ABSTRACT

A profile information display apparatus includes a database section in which a plurality of output profiles including information concerning association of a coordinate value in a first color space and a coordinate value in a second color space are accumulated, a color-value receiving section configured to receive an input of a color value indicating the coordinate value in the first color space, a color-reproduction determining section configured to determine, concerning each of the plurality of output profiles, whether the output profile is capable of reproducing the color value, a display section configured to display information, and a display control section configured to cause, based on a result of the determination of the color-reproduction determining section, the display section to display setting information concerning one or more output profiles selected from the plurality of output profiles.

The present application is based on, and claims priority from JP Application Serial Number 2019-002441, filed Jan. 10, 2019, the disclosure of which is hereby incorporated by reference herein in its entirety.

### BACKGROUND

### 1. Technical Field

The present disclosure relates to a profile information display apparatus, a profile information display method, and a non-transitory computer-readable storage medium storing a profile information display program.

### 2. Related Art

There has been known a color management system that performs color matching between devices that treat colors of images and the like. A profile associating a coordinate value in a CMYK color space or the like depending on a device and a coordinate value in a CIELAB color space or the like not depending on the device is used for the color matching. In a device such as a printer, an output profile for converting a coordinate value in a color space not depending on the device into a coordinate value in a color space depending on the device is used as the profile.

An image processing system described in JP A-2017-97600 (Patent Literature 1) evaluates whether a color gamut of document data is included in a color gamut of an output profile. When the color gamut of the document data is included in the color gamut of the output profile, the image processing system forms an image based on the document data in a recording medium. On the other hand, when the color gamut of the document data is not included in the color gamut of the output profile, the image processing system notifies a user that setting of the profile lacks consistency.

When the color gamut of the document data is not included in the color gamut of the output profile, the image processing system described in Patent Literature 1 can only inform the user that an image based on the document data cannot be reproduced. Therefore, with the image processing system described in Patent Literature 1, it is difficult to create or acquire an output profile capable of reproducing the image.

### SUMMARY

A profile information display apparatus according to an aspect of the present disclosure includes: a database section in which a plurality of output profiles including information concerning association of a coordinate value in a first color space and a coordinate value in a second color space are accumulated; a color-value receiving section configured to receive an input of a color value indicating the coordinate value in the first color space; a color-reproduction determining section configured to determine, concerning each of the plurality of output profiles, whether the output profile is capable of reproducing the color value; a display section configured to display information; and a display control section configured to cause, based on a result of the determination of the color-reproduction determining section, the display section to display setting information concerning one or more output profiles selected from the plurality of output profiles.

A profile information display method according to an aspect of the present disclosure includes: receiving an input of a color value indicating a coordinate value in a first color space; determining, concerning each of a plurality of output profiles including information concerning association of the coordinate value in the first color space and a coordinate value in a second color space, whether the output profile is capable of reproducing the color value; and displaying, based on a result of the determination, setting information concerning one or more output profiles selected from the plurality of output profiles.

A non-transitory computer-readable storage medium storing a profile information display program according to an aspect of the present disclosure causes a computer to realize: a color-value receiving function of receiving an input of a color value indicating a coordinate value in a first color space; a color-reproduction determining function of determining, concerning each of a plurality of output profiles including information concerning association of the coordinate value in the first color space and a coordinate value in a second color space, whether the output profile is capable of reproducing the color value; and a display control function of causing the display section to display based on a result of the determination of the color-reproduction determining function, setting information concerning one or more output profiles selected from the plurality of output profiles.

### BRIEF DESCRIPTION OF THE DRAWINGS

FIG. 1 is a schematic diagram showing a configuration example of a system in which a profile information display apparatus according to a first embodiment is used.

FIG. 2 is a block diagram showing the configuration of the profile information display apparatus according to the first embodiment.

FIG. 3 is a diagram showing the configuration of a profile information display program according to the first embodiment.

FIG. 4 is a diagram showing a configuration example of an output profile.

FIG. 5 is a diagram showing an example of a display image of the profile information display apparatus according to the first embodiment.

FIG. 6 is a flowchart showing the operation of the profile information display apparatus according to the first embodiment.

FIG. 7 is a block diagram showing the configuration of a profile information display apparatus according to a second embodiment.

FIG. 8 is a diagram showing a configuration example of an input profile.

FIG. 9 is a diagram showing an example of a display image of the profile information display apparatus according to the second embodiment.

FIG. 10 is a flowchart showing the operation of the profile information display apparatus according to the second embodiment.

### DESCRIPTION OF EXEMPLARY EMBODIMENTS

Preferred embodiments of the present disclosure are explained below with reference to the accompanying drawings. In the drawings, dimensions or scales of sections are different from actual dimensions or scales as appropriate. Some portions are schematically shown in order to facilitate understanding. The scope of the present disclosure is not limited to the embodiments unless it is particularly described in the following explanation that the present disclosure is limited.

### 1. First Embodiment

### 1-1. Overview of a System 100 in Which a Profile Information Display Apparatus 1 is Used

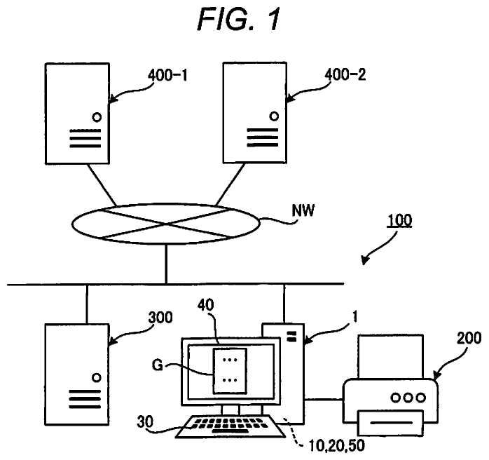

FIG. 1 is a schematic diagram showing a configuration example of a system 100 in which a profile information display apparatus 1 according to a first embodiment is used. The system 100 is a system that displays information necessary for creation or acquisition of an output profile used for color matching of an output device such as a printer. In the example shown in FIG. 1, the system 100 includes the profile information display apparatus 1, a printer 200, and a server 300. The profile information display apparatus 1 is communicably coupled to the printer 200 and the server 300. One or both of the printer 200 and the server 300 may be omitted.

The profile information display apparatus 1 receives an input of information concerning a color from a user and displays an image G including information necessary for creation or acquisition of an output profile capable of reproducing the color. The profile information display apparatus 1 determines, concerning each of an existing plurality of output profiles, whether the color is present within a color gamut of the output profile. The profile information display apparatus 1 displays an image G including setting information concerning one or more output profiles, within color gamuts of which the color is present. Therefore, the user uses, as a clue, the setting information included in the image G. Consequently, labor and time of the user for creating or acquiring an output profile capable of reproducing the color are reduced.

In the example shown in FIG. 1, the profile information display apparatus 1 is communicable with servers 400-1 and 400-2 via a network NW including the Internet. The existing plurality of output profiles are accumulated in the profile information display apparatus 1, the server 300, or the server 400-1 or 400-2.

### 1-2. Configuration of the Profile Information Display Apparatus 1

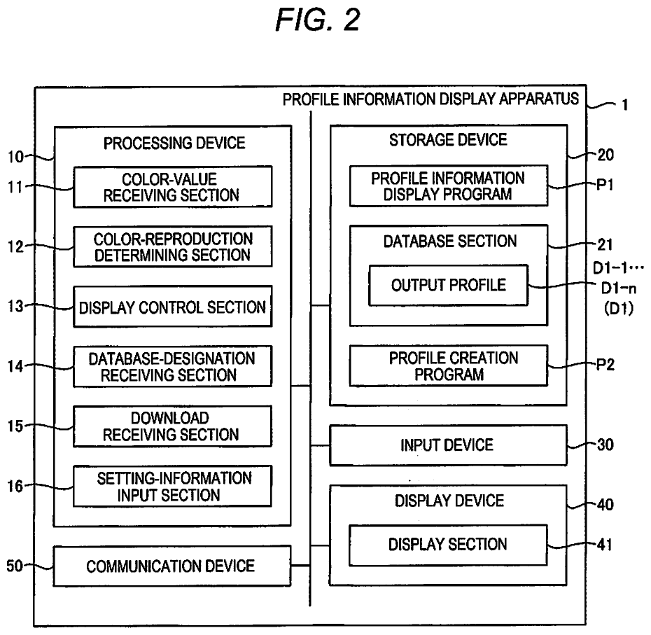

FIG. 2 is a block diagram showing the configuration of the profile information display apparatus 1 according to the first embodiment. As shown in FIG. 2, the profile information display apparatus 1 includes a processing device 10, a storage device 20, an input device 30, a display device 40, and a communication device 50. These devices are communicably coupled to one another.

The processing device 10 is a device having a function of controlling the respective sections of the profile information display apparatus 1 and a function of processing various data. The processing device 10 includes a processor such as a CPU (Central Processing Unit). The processing device 10 may be configured by a single processor or may be configured by a plurality of processors. A part or all of functions of the processing device 10 may be realized by hardware such as a DSP (Digital Signal Processor), an ASIC (Application Specific Integrated Circuit), a PLD (Programmable Logic Device), or an FPGA (Field Programmable Gate Array).

The storage device 20 is a device that stores various programs to be executed by the processing device 10 and various data to be processed by the processing device 10. The storage device 20 includes, for example, a hard disk drive or a semiconductor memory. A part or the entire storage device 20 may be provided in a storage device, a server such as a server 300, 400-1, or 400-2, or the like on the outside of the profile information display apparatus 1.

In the storage device 20 in this embodiment, a profile information display program P1, a profile creation program P2, and a plurality of (n) output profiles D1-1 to D1-n are stored; n is an integer equal to or larger than 2. The plurality of output profiles D1-1 to D1-n configure a database section 21. As explained in detail below, the profile information display program P1 is executed by the processing device 10 to realize various functions of the profile information display apparatus 1. The profile creation program P2 is executed by the processing device 10 to realize a function of creating an output profile. The profile creation program P2 may be incorporated in the profile information display program P1. The profile creation program P2 may be stored in the storage device, the server such as the server 300, 400-1, or 400-2, or the like on the outside of the profile information display apparatus 1.

As explained in detail below, each of the plurality of output profiles D1-1 to D1-n is information concerning a color characteristic of an output device such as the printer 200. Each of the plurality of output profiles D1-1 to D1-n is created according to, for example, the provision of the ICC (International Color Consortium). In the following explanation, each of the plurality of output profiles D1-1 to D1-n is referred to as output profile D1 as well. A part or the entire database section 21 may be stored in the storage device, the server such as the server 300, 400-1, or 400-2, or the like on the outside of the profile information display apparatus 1.

The input device 30 is a device that receives operation from the user. For example, the input device 30 includes a touch pad, a touch panel, or a pointing device such as a mouse. When the input device 30 includes a touch panel, the input device 30 may function as the display device 40 as well.

The display device 40 displays various images under control by the processing device 10. The display device 40 functions as a display section 41 that displays information. The display device 40 is a display device including a display panel such as a liquid crystal display panel or an organic EL (electro-luminescence) display panel.

The communication device 50 is an interface communicably coupled to an external device such as the printer 200 or the server 300, 400-1, or 400-2. For example, the communication device 50 includes interfaces such as a USB (Universal Serial Bus) and a LAN (Local Area Network). The communication device 50 may be wirelessly connected to the external device by, for example, Wi-Fi or Bluetooth or may be connected to the external device via a LAN (Local Area Network), the Internet, or the like. HDMI, Wi-Fi, and Bluetooth are respectively registered trademarks.

In the profile information display apparatus 1 having the configuration explained above, the processing device 10 reads the profile information display program P1 from the storage device 20 and executes the profile information display program P1. By executing the profile information display program Pl, the processing device 10 functions as a color-value receiving section 11, a color-reproduction determining section 12, a display control section 13, a database-designation receiving section 14, a download receiving section 15, and a setting-information input section 16.

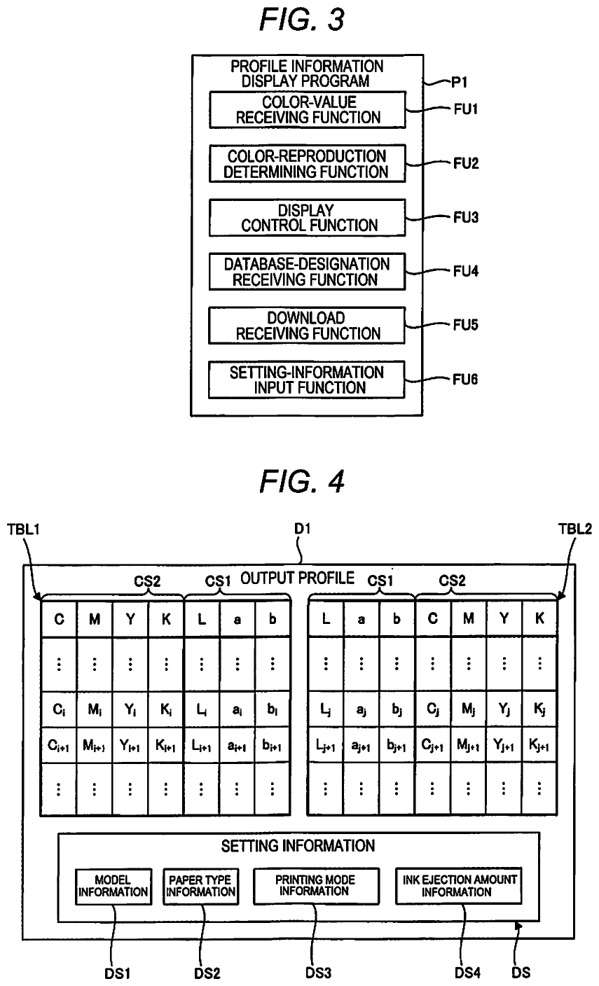

FIG. 3 is a diagram showing the configuration of the profile information display program P1 according to the first embodiment. The profile information display program P1 causes a computer to execute a color-value receiving function FU1, a color-reproduction determining function FU2, a display control function F03, a database-designation receiving function FU4, a download receiving function FU5, and a setting-information input function FU6.

The color-value receiving function FU1 shown in FIG. 3 or the color-value receiving section 11 shown in FIG. 2 receives an input of a color value T0. The input is performed using a color-value input region FI1 of the image G explained below. The color value T0 indicates a coordinate value in a color space such as CIELAB or XYZ not depending on a device. In this embodiment, as an example, the color value T0 indicates a coordinate value of the CIELAB color space. In this specification, description of “*” in “L*”, “a*”, and “b*” used in the CIELAB color space is omitted.

FIG. 4 is a diagram showing a configuration example of the output profile D1. As shown in FIG. 4, the output profile D1 includes information TBL1 and information TBL2 and setting information DS. The information TBL1 and the information TBL2 are respectively information concerning association of a coordinate value (Lᵢ, aᵢ, bᵢ) of a first color space CS1, which is a CIELAB color space, and a coordinate value (Cᵢ, Mᵢ, Yᵢ, Kᵢ) of a second color space CS2, which is a CMYK color space. More specifically, the information TBL1 is an A2B table for converting the coordinate value (Cᵢ, Mᵢ, Yᵢ, Kᵢ) of the second color space CS2 into the coordinate value (Lᵢ, aᵢ, bᵢ) of the first color space CS1. The information TBL2 is a B2A table for converting the coordinate value (Lᵢ, aᵢ, bᵢ) of the first color space CS1 into the coordinate value (Cᵢ, Mᵢ, Yᵢ, Kᵢ) of the second color space CS2. In this embodiment, since the color value T0 indicates a coordinate value of the CIELAB color space as explained above, the color value T0 is considered to indicate a coordinate value in the first color space CS1. The first color space CS1 is, for example, a color space not depending on a device, a so-called profile connection space (PCS). The second color space CS2 is, for example, a color space depending on a device. The first color space CS1 only has to be a color space not depending on a device and is not limited to the CIELAB color space and may be, for example, the XYZ color space. The second color space CS2 only has to be a color space usable by an output device and is not limited to the CMYK color space and may be, for example, a color space unique to the output device.

The setting information DS is information concerning setting during creation of the output profile D1. In FIG. 4, as an example, an output device that uses the output profile D1 is an inkjet printer. In the example shown in FIG. 4, the setting information DS includes model information DS1, paper type information DS2, printing mode information DS3, and ink ejection amount information DS4. These kinds of information are included in, for example, a header of an ICC profile. The model information DS1 is information concerning a manufacturer, a model, and an ink set of the inkjet printer. The paper type information DS2 is information concerning a type of a recording medium to be printed by the inkjet printer. The printing mode information DS3 is information concerning a printing mode of the inkjet printer. The ink ejection amount information DS4 is information concerning an ink ejection amount of the inkjet printer. The setting information DS may be managed by a file separate from the output profile D1. In this case, the processing device 10 reads and uses, as appropriate, not only the output profile D1 but also the file including the setting information DS.

The color-reproduction determining function FU2 shown in FIG. 3 or the color-reproduction determining section 12 shown in FIG. 2 determines, concerning each of the plurality of output profiles D1-1 to D1-n, whether the output profile D1 is capable of reproducing the color value T0. The determination is performed according to, for example, whether the color value T0 falls into a subspace set in the first color space CS1 to correspond to the second color space CS2 in the information TBL1 of each of the plurality of output profiles D1-1 to D1-n. The subspace is, for example, a space set using tetrahedral interpolation based on a cube having lattice points as vertexes. A table for determining whether the color value T0 is inside or outside of a color reproduction region may be stored in the output profile D1 as a tag. The determination may be performed using the tag.

The display control function FU3 shown in FIG. 3 or the display control section 13 shown in FIG. 2 causes, based on a result of the determination of the color-reproduction determining function FU2 or the color-reproduction determining section 12, the display section 41 to display the setting information DS concerning one or more output profiles D1 selected from the plurality of output profiles D1. The display control section 13 in this embodiment causes the display section 41 to display the setting information DS concerning one or more output profiles D1 determined as being capable of reproducing the color value T0.

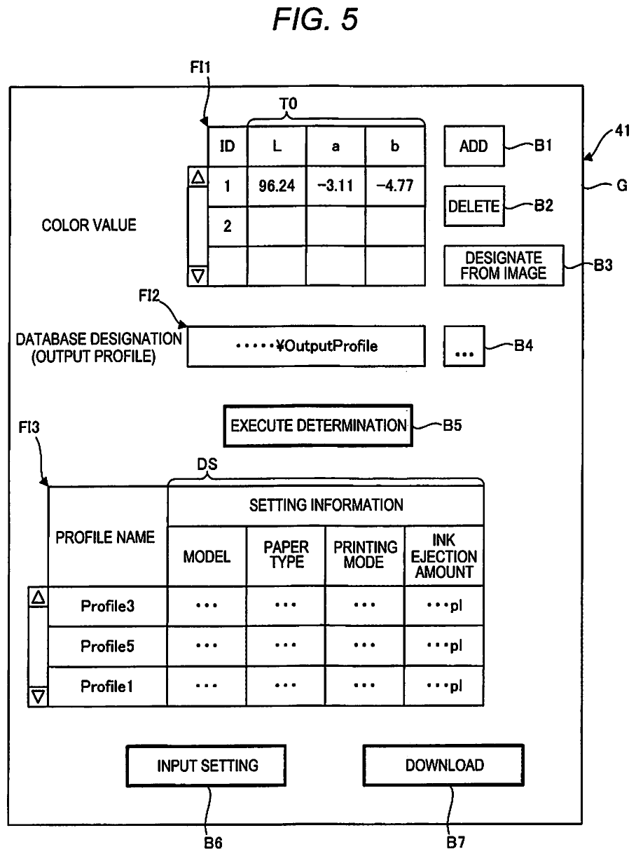

FIG. 5 is a diagram showing an example of a display image of the profile information display apparatus 1 according to the first embodiment. As shown in FIG. 5, the display control section 13 of the profile information display apparatus 1 causes the display section 41 to display the image G. The image G is an image capable of receiving operation from the user using the input device 30. The image G includes buttons B1, B2, B3, B4, B5, B6, and B7, a color-value input region FI1, a database-designation input region FI2, and a determination-result display region FI3.

The color-value input region FI1 is a region to which the color value T0 received by the color-value receiving section 11 is input. In the example shown in FIG. 5, the color-value input region FI1 includes a plurality of fields to which the color value T0 can be input. ID numbers for identification are affixed to the fields. The fields and the ID numbers can be added by operation on the button B1. The fields and the ID numbers can be deleted by operation on the button B2. The input of the color value T0 to the fields can also be performed using a color pallet appearing according to operation on the button B3. The color pallet includes, for example, a plurality of items associated with color values such as coordinate values of the CIELAB color space.

The database-designation input region FI2 is a region to which a URL or the like of a folder or a server to which the plurality of output profiles D1-1 to D1-n used for the determination of the color-reproduction determining section 12 are stored is input. The input can also be performed using a window appearing according to operation on the button B4.

The determination-result display region FI3 is a region where the setting information DS based on a determination result of the color-reproduction determining section 12 is displayed. The display is performed by operation on the button B5 after the input to the color-value input region FI1 and the database-designation input region FI2. When the button B5 is operated, the determination in the color-reproduction determining section 12 is performed and the display of the setting information DS by the display control section 13 is performed. In the example shown in FIG. 5, a plurality of kinds of setting information DS are displayed in the determination-result display region FI3. The plurality of kinds of setting information DS displayed in the determination-result display region FI3 includes the model information DS1, the paper type information DS2, the printing mode information DS3, and the ink ejection amount information DS4. In the determination-result display region FI3, one kind of setting information DS among the displayed plurality of kinds of setting information DS can be selected. The one kind of setting information DS can be input to the profile creation program P2 by operation on the button B6. After the selection, an output profile concerning the one kind of setting information DS can be downloaded from the server 300, 400-1, or 400-2 on the outside by operation on the button B7.

The database-designation receiving function FU4 shown in FIG. 3 or the database-designation receiving section 14 shown in FIG. 2 receives an instruction for designating the database section 21. The designation is performed by an input to the database-designation input region FI2.

The download receiving function FU5 shown in FIG. 3 or the download receiving section 15 shown in FIG. 2 receives an instruction for downloading the output profile 01 based on the determination result of the color-reproduction determining section 12 from the server 300, 400-1, or 400-2 on the outside. The instruction is performed by operation on the button B7.

The setting-information input function FU6 shown in FIG. 3 or the setting-information input section 16 shown in FIG. 2 inputs the setting information DS to the profile creation program P2. The input is performed by operation on the button B6.

### 1-3. Operation of the Profile Information Display Apparatus 1

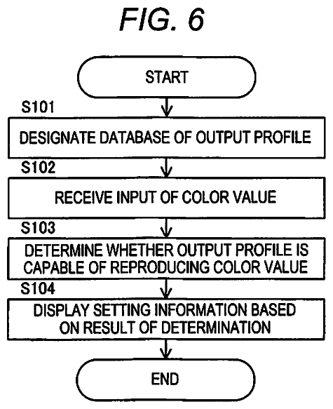

FIG. 6 is a flowchart showing the operation of the profile information display apparatus 1 according to the first embodiment. In the profile-information display apparatus 1, first, in step S101, the database-designation receiving section 14 receives an instruction for designating the database section 21. Subsequently, in step S102, the color-value receiving section 11 receives an input of the color value T0 indicating a coordinate value in the first color space CS1. Thereafter, in step S103, the color-reproduction determining section 12 determines, concerning each of the plurality of output profiles D1-1 to D1-n, whether the output profile D1 is capable of reproducing the color value T0. In step S104, the display control section 13 causes, based on a result of the determination of the color-reproduction determining section 12, the display section 41 to display the setting information DS concerning one or more output profiles D1 selected from the plurality of output profiles D1-1 to D1-n. As explained above, the profile information display apparatus 1 executes a profile information display method including steps S101 to S104.

The profile information display apparatus 1 includes the database section 21, the color-value receiving section 11, the color-reproduction determining section 12, the display section 41, and the display control section 13 as explained above. The plurality of output profiles D1-1 to D1-n including the information TBL2 concerning association of a coordinate value in the first color space CS1 and a coordinate value in the second color space CS2 are accumulated in the database section 21. The color-value receiving section 11 receives an input of the color value T0 indicating a coordinate value in the first color space CS1. The color-reproduction determining section 12 determines, concerning each of the plurality of output profiles D1-1 to D1-n, whether the output profile D1 can reproduce the color value T0. The display section 41 displays information. The display control section 13 causes, based on a result of the determination of the color-reproduction determining section 12, the display section 14 to display the setting information DS concerning one or more output profiles D1 selected from the plurality of output profiles D1-1 to D1-n.

In the profile information display apparatus 1, the setting information DS concerning one or more output profiles D1 is displayed. The setting information DS to be displayed relates to an output profile selected based on a determination result concerning whether the input color value T0 can be reproduced. The setting information DS to be displayed is considered to be information indicating conditions necessary for creation or acquisition of an output profile capable of reproducing the input color value T0. Therefore, the user can create or acquire, using the setting information DS as a clue, an output profile capable of reproducing the color value T0. Therefore, compared with when the setting information DS is not used, it is possible to reduce labor and time for creating or acquiring an output profile capable of reproducing the color value T0.

The profile information display apparatus 1 in this embodiment includes the database-designation receiving section 14 that receives an instruction for designating the database section 21. Therefore, it is possible to increase the number of usable output profiles D1. As a result, it is possible to improve, about the setting information DS to be displayed, reliability concerning reproducibility of the color value T0.

The profile information display apparatus 1 includes the download receiving section 15 that receives an instruction for downloading the output profile D1 based on a determination result of the color-reproduction determining section 12 from the server 300, 400-1, or 400-2 on the outside. Therefore, even if an output profile capable of reproducing the color value T0 is not created, it is possible to acquire the output profile capable of reproducing the color value T0. As a result, a burden on the user is reduced compared with when the output profile capable of reproducing the color value T0 is created.

The profile information display apparatus 1 includes the setting-information input section 16 that inputs the setting information DS to the profile creation program P2, which is a program for creating an output profile. Therefore, under an environment of the user, it is possible to create or acquire, based on the setting information DS to be displayed, an output profile capable of reproducing the color value T0. Compared with when the setting-information input section 16 is not used, a burden on the user in creating, with the profile creation program P2, an output profile capable of reproducing the color value T0 is reduced.

### 2. Second Embodiment

A second embodiment is explained. This embodiment is the same as the first embodiment except that information necessary for creation or acquisition of an output profile capable of reproducing a color based on image information is displayed. In the following explanation, concerning the second embodiment, differences from the first embodiment are mainly explained. Explanation of similarities to the first embodiment is omitted. In the figures used for the explanation of the second embodiment, the same components as the components in the first embodiment are denoted by the same reference numerals and signs.

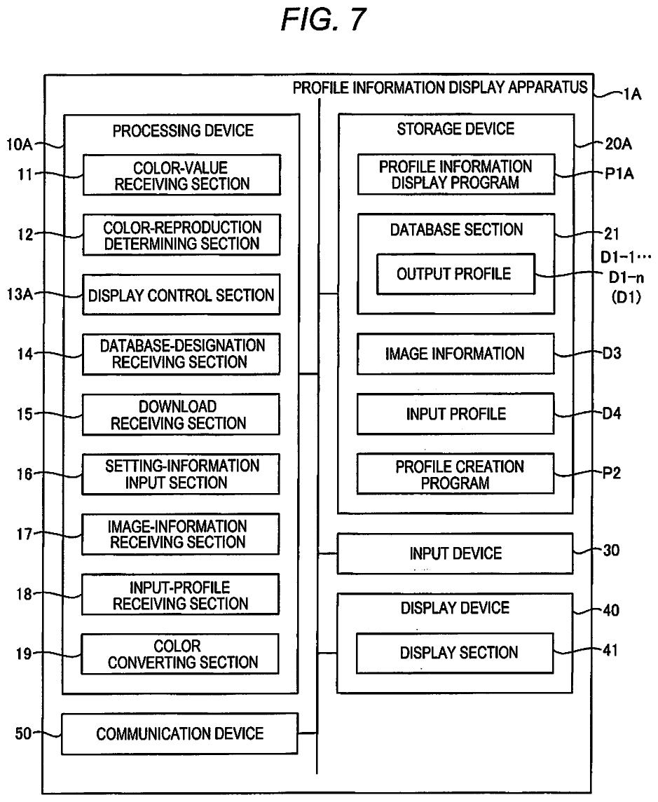

FIG. 7 is a block diagram showing the configuration of a profile information display apparatus 1A according to the second embodiment. The profile information display apparatus 1A includes a processing device 10A, a storage device 20A, the input device 30, the display device 40, and the communication device 50.

In the storage device 20A in this embodiment, besides the information stored in the storage device 20 in the first embodiment, image information D3 and an input profile D4 are stored. The image information D3 is information concerning an image of JPEG, TIFF, or the like. The image information D3 and the input profile D4 may be stored in a storage device, a server such as a server 300, 400-1, or 400-2, or the like on the outside of the profile information display apparatus 1A.

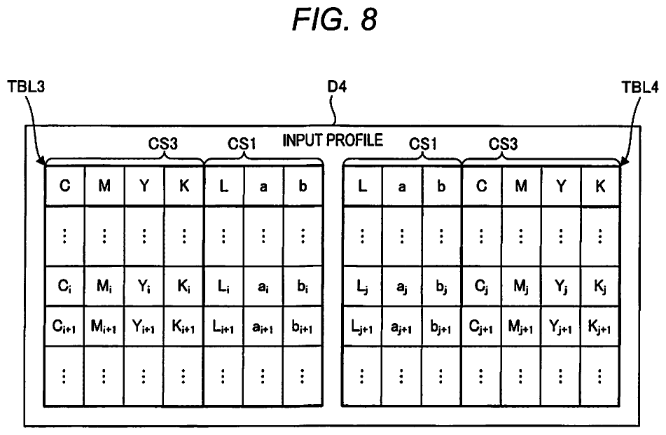

FIG. 8 is a diagram showing a configuration example of the input profile D4. As shown in FIG. 8, the input profile D4 includes information TBL3 and information TBL4. The information TBL3 and the information TBL4 are respectively information concerning association of a coordinate value (Lᵢ, aᵢ, bᵢ) of the first color space CS1, which is a CIELAB color space, and a coordinate value (Cᵢ, Mᵢ, Yᵢ, Kᵢ) of a third color space CS3, which is a CMYK color space. More specifically, the information TBL3 is an A2B table for converting the coordinate value (Cᵢ, Mᵢ, Yᵢ, Kᵢ) of the third color space CS3 into the coordinate value (Lᵢ, aᵢ, bᵢ) of the first color space CS1. The information TBL4 is a B2A table for converting the coordinate value (Lᵢ, aᵢ, bᵢ) of the first color space CS1 into the coordinate value (Cᵢ, Mᵢ, Yᵢ, Kᵢ) of the third color space CS3. The third color space CS3 is, for example, a color space depending on a device. The third color space CS3 only has to be a color space usable by an input device and is not limited to the CMYK color space and may be, for example, a color space unique to the input device.

In the storage device 20A, a profile information display program P1A is stored instead of the profile information display program Pl. In the profile information display apparatus 1A, the processing device 10A reads the profile information display program P1A from the storage device 20A and executes the profile information display program P1A. By executing the profile information display program P1A, the processing device 10A functions as the color-value receiving section 11, the color-reproduction determining section 12, a display control section 13A, the database-designation receiving section 14, the download receiving section 15, the setting-information input section 16, an image-information receiving section 17, an input-profile receiving section 18, and a color converting section 19.

The image-information receiving section 17 receives an input of the image information D3. On the other hand, the input-profile receiving section 18 receives an input of the input profile D4 including information concerning association of a coordinate value in the first color space CS1 and a coordinate value in the third color space CS3. The color converting section 19 converts the image information D3 into the color value T0 for each of pixels using the input profile D4. The color value T0 after the conversion is used for the determination in the color-reproduction determining section 12 as in the first embodiment. The display control section 13A causes, based on a result of the determination of the color-reproduction determining section 12, the display section 41 to display the setting information DS concerning one or more output profiles D1 selected from the plurality of output profiles D1-1 to D1-n. The display control section 13A in this embodiment causes the display section 41 to display the setting information DS concerning one or more output profiles D1, a ratio of color reproduction of which based on the determination result of the color-reproduction determining section 12 is equal to or higher than a predetermined ratio. The ratio is a ratio of the number of pixels determined as reproducible by the color-reproduction determining section 12 in a total number of pixels of the image information D3. For example, based on whether the ratio is equal to or higher than a standard of 80%, the setting information DS concerning one or more output profiles D1, the ratio of which is 80% or more, is displayed. The standard may be fixed or may be variable.

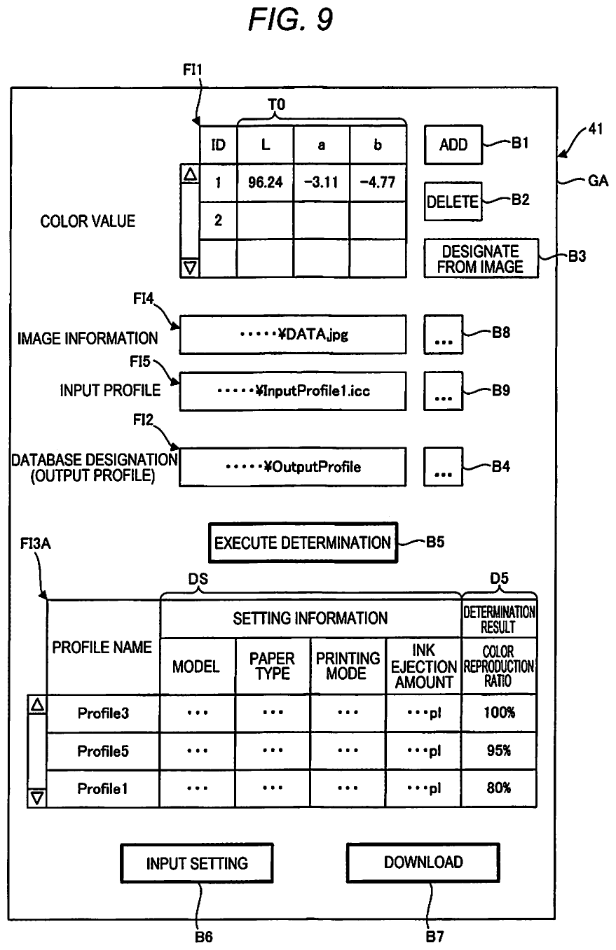

FIG. 9 is a diagram showing an example of a display image of the profile information display apparatus lA according to the second embodiment. As shown in FIG. 9, the display control section 13A of the profile information display apparatus 1A causes the display section 41 to display an image GA. The image GA is an image capable of receiving operation from a user using the input device 30. The image GA includes a determination-result display region FI3A instead of the determination-result display region FI3 in the first embodiment. The image GA includes buttons B8 and B9, an image-information input region FI4, and an input-profile input region FI5 in addition to the display content of the image G in the first embodiment.

The image-information input region FI4 is a region to which a URL or the like of a folder or a server in which the image information D3 received by the image-information receiving section 17 is stored is input. The input can also be performed using a window appearing according to operation on the button B8.

The input-profile input region FI5 is a region to which a URL or the like of a folder or a server in which the input profile D4 received by the input-profile receiving section 18 is stored is input. The input can also be performed using a window appearing according to operation of the button B9.

The determination-result display region FI3A is a region where the setting information DS based on a determination result of the color-reproduction determining section 12 is displayed. The determination-result display region FI3A includes, in addition to the display content of the determination-result display region FI3A, information D5 concerning a ratio of the number of pixels determined as reproducible by the color-reproduction determining section 12 in the total number of pixels of the image information D3. That is, the display control section 13A in this embodiment causes the display section 41 to display the information D5 concerning the ratio in addition to the setting information DS. When the number of the setting information DS to be displayed is plural, for example, a plurality of kinds of setting information DS are displayed side by side in the order of the ratio.

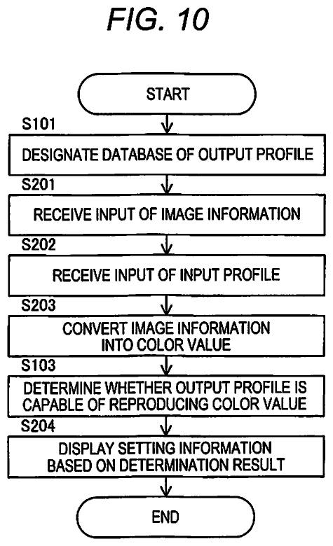

FIG. 10 is a flowchart showing the operation of the profile information display apparatus 1A according to the second embodiment. In the profile information display apparatus 1A, first, in step S101, the database-designation receiving section 14 receives an instruction for designating the database section 21. Subsequently, in step S201, the image-information receiving section 17 receives an input of the image information D3. Thereafter, in step S202, the input-profile receiving section 18 receives an input of the input profile D4. Thereafter, in step S203, the color converting section 19 converts the image information D3 into the color value T0 for each of pixels using the input profile D4. As in the first embodiment, after the execution of step S103, in step S204, the display control section 13 causes, based on a determination result of the color-reproduction determining section 12, the display section 41 to display the setting information DS and the information D5. The order of steps S101, S201, and S202 is not limited to the order shown in FIG. 10 and is optional.

The profile information display apparatus 1A includes the image-information receiving section 17, the input-profile receiving section 18, and the color converting section 19 as explained above. The image-information receiving section 17 receives an input of the image information D3. On the other hand, the input-profile receiving section receives an input of the input profile D4 including information concerning association of a coordinate value in the first color space CS1 and a coordinate value in the third color space CS3. The color converting section 19 converts the image information D3 into the color value T0 for each of pixels using the input profile D4. Therefore, the color-reproduction determining section 12 determines whether the output profile D1 is capable of reproducing the image information D3 for each of pixels. As a result, the setting information DS can be displayed as information indicating conditions necessary for creation or acquisition of an output profile capable of reproducing the image information D3. Therefore, the user can create or acquire, using the setting information DS as a clue, an output profile capable of reproducing the image information D3.

The display control section 13A in this embodiment selects one or more output profiles from the plurality of output profiles D1-1 to D1-n based on a ratio of the number of pixels determined as reproducible by the color-reproduction determining section 12 in the total number of pixels of the image information D3. Therefore, even when the output profile D1, the ratio of which is 100%, is absent, it is possible to display the setting information DS concerning the output profile D1, the ratio of which is equal to or higher than a predetermined ratio. Therefore, compared with when only the setting information DS concerning the output profile D1, the ratio of which is 100%, is displayed, it is possible to improve possibility of creation or acquisition of an output profile capable of reproducing the image information D3.

The display control section 13A selects two or more output profiles D1 from the plurality of output profiles D1-1 to D1-n. Therefore, it is possible to display two or more kinds of setting information DS. The display has an advantage that room for choice of the setting information DS by the user increases compared with when the number of kinds of setting information DS to be displays is one.

Further, the display control section 13A causes the display section 41 to display the information D5 concerning the ratio. Therefore, it is possible to use the information D5 as an indicator indicating, about the setting information DS to be displayed, reliability concerning reproducibility of the color value T0. As a result, an output profile within a range requested by the user is easily obtained.

### 3. Modifications

The profile information display apparatus, the profile information display method, and the profile information display program according to the present disclosure are explained based on the embodiments shown in the figures. However, the present disclosure is not limited to the embodiments. The components of the sections of the present disclosure can be replaced with any components that exert the same functions as the functions in the embodiments. Any components can be added. In the present disclosure, any components in the embodiments may be combined.

In the embodiments, the configuration is illustrated in which one or more output profiles D1 are selected from the plurality of output profiles D1-1 to D1-n using only the determination result of the color-reproduction determining section 12. However, the present disclosure is not limited to the configuration. For example, input information to the profile information display apparatus 1 may be learned by machine learning or the like. One or more output profiles D1 may be selected from the plurality of output profiles D1-1 to D1-n using the learned information in addition to the determination result of the color-reproduction determining section 12. Examples of the input information used for the machine learning include the model information DS1, the paper type information DS2, the printing mode information DS3, and the ink ejection amount information DS4.

In the embodiments, the configuration is illustrated in which the profile information display program is installed in the computer such as a personal computer. However, the present disclosure is not limited to the configuration. For example, the profile information display program may be installed in an output device such as a printer or a portable device such as a tablet terminal or a smartphone.

What is claimed is:

1. A profile information display apparatus comprising:
a database section in which a plurality of output profiles including information concerning association of a coordinate value in a first color space and a coordinate value in a second color space are accumulated;
a color-value receiving section configured to receive an input of a color value indicating the coordinate value in the first color space;
a color-reproduction determining section configured to determine, concerning each of the plurality of output profiles, whether the output profile is configured to reproduce the color value;
a display section configured to display information; and
a display control section configured to cause, based on a result of the determination of the color-reproduction determining section, the display section to display setting information concerning one or more output profiles selected from the plurality of output profiles.

2. The profile information display apparatus according to claim 1, further comprising:
an image-information receiving section configured to receive an input of image information;
an input-profile receiving section configured to receive an input of an input profile including information concerning association of the coordinate value in the first color space and a coordinate value in a third color space; and
a color converting section configured to convert the image information into the color value for each of pixels using the input profile.

3. The profile information display apparatus according to claim 2, wherein the display control section selects the one or more output profiles from the plurality of output profiles based on a ratio of a number of pixels determined as reproducible by the color-reproduction determining section in a total number of pixels of the image information.

4. The profile information display apparatus according to claim 3, wherein the display control section selects two or more output profiles as the one or more output profiles from the plurality of output profiles.

5. The profile information display apparatus according to claim 3, wherein the display control section causes the display section to display information concerning the ratio.

6. The profile information display apparatus according to claim 1, further comprising a download receiving section configured to receive an instruction for downloading an output profile based on the determination result of the color-reproduction determining section from a server on the outside.

7. The profile information display apparatus according to claim 1, further comprising a setting-information input section configured to input the setting information to a program for creating an output profile.

8. The profile information display apparatus according to claim 1, further comprising a database-designation receiving section configured to receive an instruction for designating the database section.

9. A profile information display method comprising:
receiving an input of a color value indicating a coordinate value in a first color space;
determining, concerning each of a plurality of output profiles including information concerning association of the coordinate value in the first color space and a coordinate value in a second color space, whether the output profile is configured to reproduce the color value; and
displaying, based on a result of the determination, setting information concerning one or more output profiles selected from the plurality of output profiles.

10. A non-transitory computer-readable storage medium storing a profile information display program for causing a computer to realize:
a color-value receiving function of receiving an input of a color value indicating a coordinate value in a first color space;
a color-reproduction determining function of determining, concerning each of a plurality of output profiles including information concerning association of the coordinate value in the first color space and a coordinate value in a second color space, whether the output profile is configured to reproduce the color value; and
a display control function of causing the display section to display based on a result of the determination of the color-reproduction determining function, setting information concerning one or more output profiles selected from the plurality of output profiles.
